(19) United States
(12) Patent Application Publication
(10) Pub. No.: US 2010/0138295 A1
(43) Pub. Date: Jun. 3, 2010

(54) MOBILE WIDGET DASHBOARD

(75) Inventors: Mark Caron, Ridgewood, NJ (US); Tony Costa, Green Brook, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: SNAC, INC., New York, NY (US)

(21) Appl. No.: 12/597,463

(22) PCT Filed: Apr. 23, 2008
(86) PCT No.: PCT/US08/61278

§ 371 Date: Oct. 23, 2009

Related U.S. Application Data
(60) Provisional application No. 60/913,352, filed on Apr. 23, 2007.

(51) Int. Cl. G06F 3/048; G06Q 30/00

(52) U.S. Cl. 705/14.49; 715/835

(57) ABSTRACT

The present invention is a method and system for the display of information on a mobile device that overcomes the difficulties such as the small screen size. The information is displayed via widgets having multiple levels of display and interaction. At a first dashboard level the widgets may be represented by live icons that have an information display area capable of displaying a first level of information relevant to said widget while remaining in iconic form. User interaction with the widget may result in multiple levels of data being aggregated and displayed by the widget in multiple levels of screens. The widgets may also display advertising, that may be targeted, in, for instance, a banner.

### CROSS REFERENCE TO APPLICATIONS

This application is related to, and claims priority from, U.S. Provisional Patent application No. 60/913,352 filed on Apr. 23, 2007, by Costa et al. entitled “Mobile Widget Dashboard”, the contents of which are hereby incorporated by reference.

### TECHNICAL FIELD

The present invention relates to the display of information on mobile device screens, and more particularly to systems and methods to facilitate the use of dashboards, live icons and widgets to display information and targeted advertising on mobile device screens.

### BACKGROUND ART

In the field of graphical user interfaces, widgets are well known interface elements that typically perform common tasks and/or provide fast, direct access to specific information or applications without a user having to traverse multiple levels of navigation or interact with multiple applications. Widgets may, for instance, be capable of connecting to the Internet or an enterprise network in order to give a user fast access to data and services such as, but not limited to, email, enterprise information, instant messaging, social networks, news, sports, blogs and other information or web-services that are of frequent interest to a user.

A collection of widgets is typically displayed as an array of icons in a container referred to as a dashboard. The dashboard may function as an alternative home screen, or default screen, for a user. A dashboard is typically populated with a selection of widgets related to the users specific interests. A particular widget is typically activated by moving a cursor onto the icon on the dashboard and clicking a button. On activation, the selected widget performs its intended function. A widget's function may, for instance, consist of fetching information from a particular website and displaying that information on the user's screen in some pre-configured fashion.

Widgets and dashboards are well-known in the field of computer graphic interfaces and have been described in detail in, for instance, US Patent Publication no. 2007/0162850 by Adler et al. published on Jul. 12, 2007 entitled “Sports-related widgets”, US Patent Publication no. 2008/0034314 by Louch et al. published on Feb. 7, 2008 “Management and generation of dashboards” and US Patent publication no. 2008/0010133 by Pyhalammi et al. Jan. 10, 2008 entitled “Advertising based on widgets”, the contents of all of which are hereby incorporated by references.

Their use, however, on mobile devices, such as mobile phones, is more problematic because the mobile devices typically have significantly smaller screens, more limited screen navigation capability and intermittent and expensive access to the Internet. The problems to be overcome in using dashboards and widgets in a mobile environment, therefore, include the problem of displaying items intended for a large screen on a small screen, the issue of how to ensure that the latest information is available when wanted by the user or the widget, and the need to minimize the cost of accessing the information, particularly the cost of any mobile phone connections.

### DISCLOSURE OF INVENTION

The present invention relates to systems and methods for the quick and easy display of personalized information on mobile devices, and within a mobile environment.

In a preferred embodiment, problems associated with presenting information on mobile device may, for instance, be overcome using one or more of a combination of innovative techniques. These innovative techniques may include the zero-click optimization of the display of live information on the limited screen sizes of mobile phones, i.e., reformatting the information for optimal display without requiring any action or input from the user. The innovative techniques may also, or instead, include performing dynamic updating of information as a background task. They may also, or instead, include pre-caching additional relevant information so that it is available for immediate display once those levels are selected.

In an exemplary embodiment, the display of information is via widgets having multiple levels of display and interaction. At a first dashboard level the widgets may be represented live icons that have an information display area capable of displaying a first level of information relevant to said widget while remaining in iconic form.

User interaction with the widget may then result in multiple levels of data being aggregated and displayed by the widget in multiple levels of screens.

The widgets may also display advertising, that may be targeted, in, for instance, a banner.

These and other features of the invention will be more fully understood by references to the following drawings.

### BRIEF DESCRIPTION OF DRAWINGS

FIG. 1A shows an exemplary top-level display in accordance with the present invention.

FIG. 1B shows an exemplary second-level display in accordance with the present invention.

FIG. 1C shows an exemplary third-level display in accordance with the present invention.

FIG. 2A shows an alternative, exemplary top-level display in accordance with the present invention.

FIG. 2B shows an alternative exemplary second-level display in accordance with the present invention.

FIG. 2C shows an alternative exemplary third-level display in accordance with the present invention.

FIG. 3 shows an exemplary widget delivery and display system in accordance with the present invention.

FIG. 4 shows a flow diagram of exemplary steps in implementing a display method in accordance with the present invention.

FIG. 5 shows a flow diagram of exemplary steps in implementing a widget delivery method in accordance with the present invention.

FIG. 6 shows a flow diagram of exemplary steps in implementing a widget management method in accordance with the present invention.

### BEST MODE FOR CARRYING OUT THE INVENTION

The present invention relates to the display of information on mobile device screens, and more particularly to systems and methods to facilitate the use of dashboards, live icons and widgets to display information and targeted advertising on mobile device screens.

In a preferred embodiment of the present invention, a widget engine that may be downloadable, provides support for widgets that may provide access to, and the display of, multimedia data and/or access to an application. The widget engine may, for instance, operate in conjunction with a server that may have access to the internet. The widget engine preferably provides the mobile device with an interface that is intuitive or web-like in functionality. For instance, users may select individual widgets that are related to the users interests or needs. The user may then choose to arrange icons for the selected widgets as a display on the screen of a mobile device such as, but not limited to, a mobile telephone or personal data assistant. The widget icons may be live icons that display information that is updated. In this way a user may see a first level of information related to a widget by looking at the live icons displayed on the dashboard. The user may select one of the widgets on the dashboard using any of the standard icon selection methods such as, but not limited to, a cursor controlled by the phone buttons, a touch screen control panel or by touching the live icons. Selecting a live icon may result in further data related to that widget being displayed on the mobile device by the widget engine. The data may be aggregated in a continuous or a periodic manner and may be cached so that when a widget is selected, display of the data aggregated by the selected widget is performed rapidly. In a preferred embodiment, the service may be supported wholly, or in part, by advertising that may be targeted to, for instance, a user's demographic profile. The advertising may also or instead be targeted to the type of widget being used and may be displayed in a banner on the widget or dashboard.

In a preferred embodiment, the present invention enables a service that may, for instance, be used to keep users up to date on information that is relevant or important to, for instance, their daily lives. The information may, for instance, include, but is not limited to, personal communications such as emails and instant messaging; personal web service content such as social networking sites, content sharing sites, community sites and blogs; data related to the weather, sports, news, traffic, stock quotes, T.V. listings and horoscopes; and to quick diversions such as simple games, trivia, jokes, quizzes, polls and contests.

In a preferred embodiment, the widgets are defined by scripts that are processed by a widget and dashboard engine running on the mobile device and the results of the processing are presented on the dashboard that is a graphic display on a mobile device screen. In an exemplary embodiment, the widget scripts may be XML syntax files that utilize a Dashboard scripting language to define widget services and parameters. For instance the widget script may be, but is not limited to, a description of the elements composing the graphical part, or parts, of the widget, and a definition of the behavior of the widget. Widgets may operate as stand-alone functions, or communicate with web servers or application servers directly or via a network such as, but not limited to, the Internet. The widgets may have multiple levels of in information display and user interaction and may present advertising, that may be targeted, at one or more of the levels of interaction.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

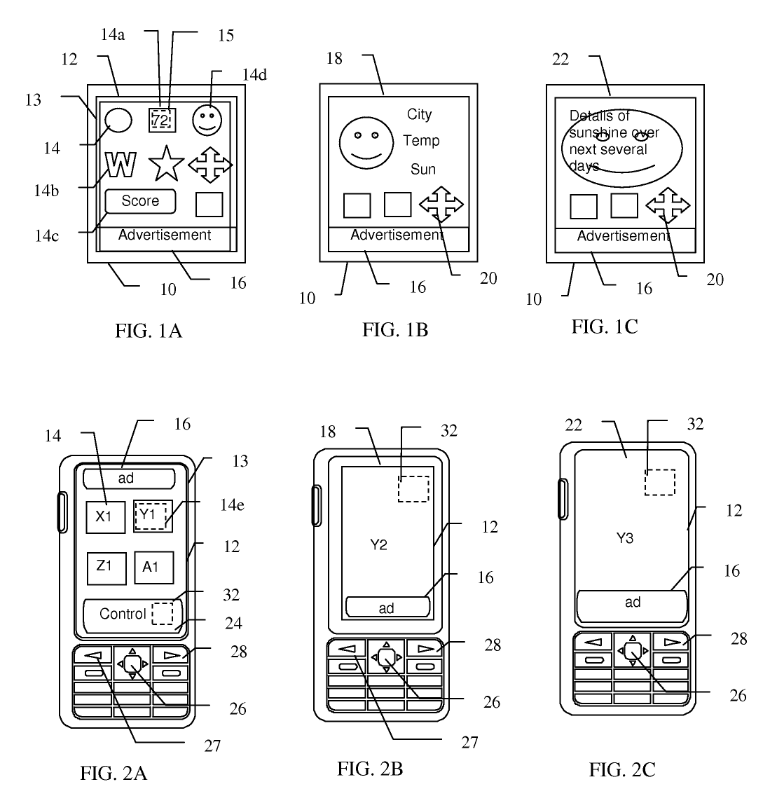

FIG. 1A shows an exemplary top-level display in accordance with the present invention. A mobile device 10 has a display 12 on which a dashboard 13 is displayed. The dashboard 13 contains a number of icons 14. The icons 14 may be simple icons that when selected, activate the widget engine to display a next level of information related to the widget. Or they may be live icons 14a. The live icon live 14a, for instance, has a display area 15. The display area 15 may, for instance, be used to display alpha-numeric information that may, for instance, relate to the weather, the stock exchange or the score of a sporting event. Alternatively, the entire live icon may be the display area 15 and the icon live may provide information via its shape or color. Live icon 14b, for instance, is intended to indicate an icon whose shape is in the form of a single letter that may, for instance, indicate the state of a sporting event, in which W may indicate that a specific team is winning a game, or has won a game, while an L may indicate that the team was loosing. Live icon 14d, for instance, may represent a weather widget and the icons shape may indicate an aspect of the weather. A smiling face may, for instance, represent current or forecast good weather, while a sad face may for, instance, represent bad weather. The information supplied to the widget may, for instance, be updated in real-time. The real-time updating may be either “pushed” to the widget from an external server or “pulled” by software operating on the mobile device 10.

The dashboard 13 may also contain an advertising banner 16. The advertising banner 16 may, for instance, contain demographically targeted advertising delivered from an advertising server. The advertising banner 16 may be updated in real-time.

FIG. 1B shows an exemplary second-level display in accordance with the present invention. When a user selects a particular widget by, for instance, moving a cursor over the corresponding icon and pushing a button, a second level display of the widget 18 may be displayed. The second level display of the widget 18 may, for instance, display a second level of information relevant to the widget and which may have been aggregated by the widget engine prior to selection of the widget. The second level display of the widget 18 may also display an icon 20 that corresponds to a possible third level of information relevant to the selected widget.

Information relevant to the second level display of the widget 18 may be fetched and cached in real-time so that it is available for display as soon as the widget is selected.

The advertising banner 16 may be updated or changed when a widget is selected. Information or data intended for the advertising banner 16 may be fetched and cached in real-time so that it is ready for display immediately the widget is selected. The advertising banner 16 may display different advertising depending on which widget is selected.

FIG. 1C shows an exemplary third-level display in accordance with the present invention. When a user at the second level display of the widget 18 selects an icon 20, a third level display of the widget 22 may be displayed. The third level display of the widget 22 may, for instance, display a third level of information relevant to the widget and which may have been aggregated by the widget engine prior to selection of the widget. The third level display of the widget 22 may also display an icon 20 that corresponds to a possible further level of information relevant to the selected widget.

FIG. 2A shows an alternative, exemplary top-level display in accordance with the present invention. The mobile device 10, that may, for instance, be a mobile phone, has a display 12 on which a dashboard 13 is displayed. The dashboard 13 may, for instance, be an alternate home or default screen. The dashboard 13 may have a collection of icons 14 that are representative of widgets. The widgets may, for instance have been selected and configured to meet a users specific interests. The icons 14 representing the widgets may be arranged in a pattern by the user. Some or all of the icons 14 may live icons that are capable of displaying or indicating information related to the widget while remaining in iconic form. The dashboard 13 may include an advertising banner 16 that may, for instance, display targeted advertising. The user may, for instance, use the mobile device 10's five-way navigation button 26 to navigate from icon to icon. The five-way navigation button 26 is typically capable of navigation left, right, up, down and performing an action. The currently selected icon is typically highlighted in some fashion including, but not limited to, a change of shape or intensity or a vibrating appearance. The dashboard 13 may also, or instead, have a control banner 24, that may be used to display targeted advertising and navigate or select icons. The control banner 24 may have one or more interactive selectable elements 32. Selection of the interactive selectable elements 32 may, for instance, perform functions such as, but not limited to, launching a full screen ad associated with an ad being displayed in the control banner 24; acting as an embedded click-to-call link that automatically dials a pre-defined phone number when selected; acting as an embedded click-to-SMS button that automatically sends a text message to a pre-defined phone number when selected; acting as an embedded link that automatically launches an HTML browser that may connect to a pre-defined website; acting as an embedded link that automatically launches an application on the mobile device; and acting as an embedded click-to-WAP link that automatically launches a WAP browser to a pre-defined WAP site when activated. The interactive selectable elements 32 may include links to cached content, links to data that needs to be retrieved directly and cannot be cached.

In one embodiment, the ads displayed in the control banner 24 or launched in the full-screen display, may be displayed by progressive build up. In the progressive build up, a simple banner may be shown at first. The longer the user lingers at the screen displaying the ad, the more sophisticated the ad may become. For instance, the ad may change, move, grow or become animated.

FIG. 2B shows an alternative exemplary second-level display in accordance with the present invention. By selecting icon 14e, the second level display of that widget 18 is now displayed on the screen. The advertising banner 16 may be the same ad displayed on the dashboard 13 or it may be a new advertisement served up by an ad server in response to the selection of this particular widget. The second level display of the widget 18 may also include one or more interactive selectable elements 32.

FIG. 2C shows an alternative exemplary third-level display in accordance with the present invention.

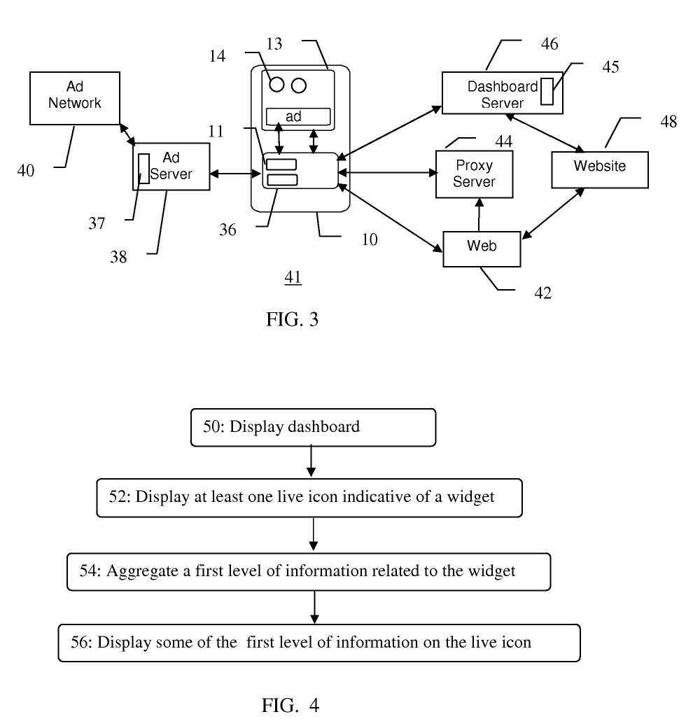

FIG. 3 shows an exemplary widget delivery and display system 41 in accordance with the present invention. The mobile device 10 contains a widget and dashboard engine 36. The widget and dashboard engine 36 may be one or more software modules that control the widgets. The widgets are typically software scripts may be XML syntax files that utilize a Dashboard scripting language to define widget services and parameters. For instance the widget script 11 may be, but is not limited to, a description of the elements composing the graphical part, or parts, of the widget, and a definition of the behavior of the widget. Widget scripts 11 may operate as stand-alone functions, or communicate with web servers or application servers directly or via a network such as, but not limited to, the Internet. The widget script 11 may enable multiple levels of information display and user interaction. The widget script 11 may also, or instead, enable the presentation of advertising, that may be targeted, at one or more of the levels of interaction. The display of advertising may occur in a control banner 24 that may be displayed along with widget icons 14 on the dashboard 13. The widget and dashboard engine 36 may also aggregates data for the widgets. Depending on the widget, the data aggregation may be done from a website 48 directly via the web 42 or via a proxy server 44. The proxy server 44 may, for instance, reformat the data from the website 48 in a form that is more suitable for display on the mobile device 10.

The widget delivery and display system 41 may also include an ad server 38. The ad server 38 may, for instance, serve targeted ads to the widget and dashboard engine 36. The ads may be targeted by user demographics or widget or a combination thereof. The ad server 38 may obtain ads from an ad network 40.

The ad server 38 may perform a variety of functions, including, but not limited to, pushing ads to the widget and dashboard engine 36, optimizing ads for display on the mobile device 10, assigning appropriate metadata to the ads, managing distribution and targeting of the ads, recording the user experience of the ads, aggregating campaign metrics for the ads. The ad server 38 may also be integrated with a ad network 40 for access to a broader inventory of ads.

The ad server 38 may also be responsible for targeting the ads based on factors such as, but not limited to, a choice of specified users, geo-targeting based on a users location or home address, time targeting based on a the date and/or time of day, the users type of mobile device or the carrier that the user subscribes to for their mobile device, or a combination thereof.

The widget delivery and display system 41 may include a dashboard server 46. The dashboard server 46 may be used to distribute widgets as well as the widget and dashboard engine 36. The dashboard server 46 may also maintain and synchronize databases of user demographics, user dashboard layout, user widget selection and user widget configuration. In one embodiment, the dashboard server 46 may control an individual user's dashboard 13. The dashboard server 46 control of an individual user's dashboard 13 may, for instance, include, but is not limited to, control of widget placement on the dashboard 13, control of widget size and appearance, including, but not limited to, color and 3-D appearance, what additional levels of access can be reached, and what advertisements are displayed. The dashboard server 46 control of the dashboard and widgets may be accomplished in real-time.

In a preferred embodiment, each widget and dashboard engine 36 is assigned a unique identifier, the dashboard identifier number, so that may be tracked and associated with an individual user and/or a group of users. The widget and dashboard engine 36 may also track total usage for each widget. Widget tracking may, for instance, take the form of keeping track of the kilobytes of information supplied to the widget, or the time the widget is displayed on the screen, with suitable weighting for which level of the widget is being displayed, or some combination thereof. The widget and dashboard engine 36 may also generate alerts when a widget receives an update. The widget update alert may be, but is not limited to, an audio alert, a visual alert such as a pop-up graphic appearing on the display 12, a vibration alert or some combination thereof.

The dashboard 13 and the widget icons 14, as well as the second level display of the widget 18 and the third level display of the widget 22 may all be dynamically zero-click changed, i.e., changed without user intervention. The changes may be effected by the widget and dashboard engine 36, the ad server 38 or the dashboard server 46 or by some combination thereof operating cooperatively. The changes may be responsive to observed user behavior such as, but not limited to, widget selection, lack of activity, volume or lighting adjustment, sound or voice input or some combination thereof. The changes may also, or instead, be responsive to a change in external information or context such as, but not limited to, breaking news, a change in score, a stock index reaching a predefined threshold, a commodity price reaching a predefined threshold or a change in a forecast such as, but not limited to, a change or update to a weather forecast. The changes may also be reflective of a commercial transaction such as, but not limited to, the desire of an advertiser to connect with the user.

In an exemplary embodiment the widget and dashboard engine 36 may be customized to allow a service provider to meet their needs, or the needs of a business partner or client. The widget and dashboard engine 36 may, for instance, be marked to identify it as having been downloaded from a specific entity, such as, but not limited to, a specific partner or client. The dashboard 13 may, for instance, be configured to assign a permanent, non-movable location to a specific widget icon 14 that may also be identifiable as being associated with a particular entity such as, but not limited to, a partner or a client. The dashboard 13 may be configured to have a particular, default selection of widgets when the widget and dashboard engine 36 is first downloaded and run. The default selection of widget icons 14 may, for instance, be reflective of the source from which the widget and dashboard engine 36 was downloaded.

The dashboard server 46 may, for instance, be configured to make certain selections of widgets available to users based on some factor such as, but not limited to, the source from which the widget and dashboard engine 36 was downloaded.

The ad server 38 be configured to target certain advertisement to users based on some factor such as, but not limited to, the source from which the widget and dashboard engine 36 was downloaded.

The widget and dashboard engine 36, the ad server 38 or the dashboard server 46, or some combination thereof, may be configured to control the refresh rate of one or more widgets, widget icons 14, second level displays of the widgets 18 or third level displays of the widgets 22, or some combination thereof. Controlling the refresh rate may be done to, for instance, to minimize, maximize or optimize data traffic, or to minimize battery drain. Controlling the refresh rate may also or instead be responsive to observed user behavior and/or a change in context such as, but not limited to, a change in score, or some combination thereof.

FIG. 4 shows a flow diagram of exemplary steps in implementing a display method in accordance with the present invention. In step 50, the widget and dashboard engine 36 displays a dashboard. In step 52, the widget and dashboard engine 36 may then display one or more widget icons 14 at least one of which may be a live icon. In step 54, the widget and dashboard engine 36 aggregates a first level of information relevant to the widget represented by the live icon. The data aggregation may be directly from a website 48 via the web 42 or it may occur via a proxy server 44 that converts the website 48 data into a format more suitable for display on the mobile device 10. In step 56, the widget and dashboard engine 36 displays at least some of the first level of information that it has aggregated on a display area 15 of the live icon.

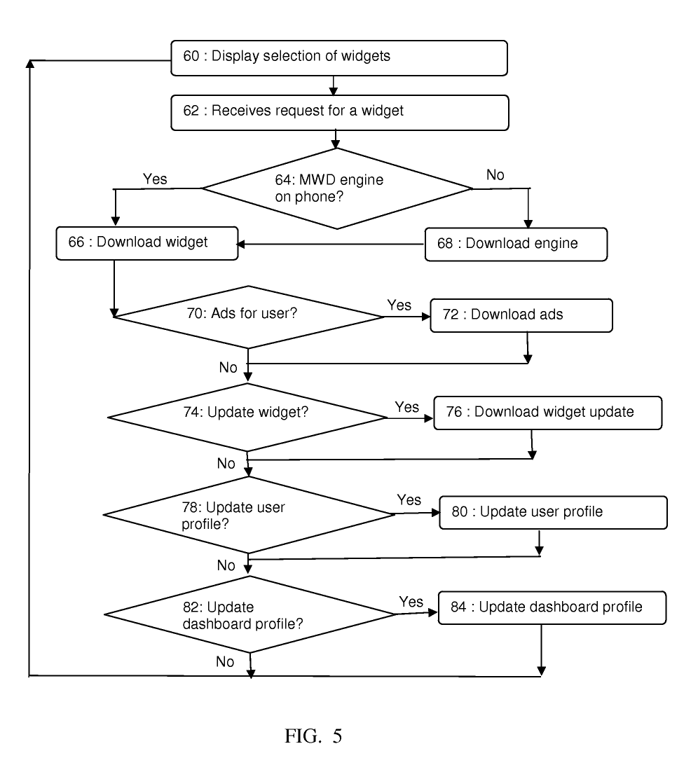

FIG. 5 shows a flow diagram of exemplary steps in implementing a widget delivery method in accordance with the present invention.

In step 60, a dashboard server software module 45 causes a selection of widgets to be displayed on, for instance, a website 48. In step 62 the dashboard server software module 45 receives a request for a widget from a mobile device 10. The request may come via the website 48 or directly from the mobile device 10. In step 64 the dashboard server software module 45 determines whether the mobile device 10 has a widget and dashboard engine 36 installed on it. If the mobile device 10 does not have widget and dashboard engine 36 installed, the dashboard server software module 45 downloads an installable version of the widget and dashboard engine 36 to the mobile device 10 prior to going to step 66 and down loading the widget. In one embodiment, the dashboard server software module 45 may also handle some or all of the advertising distribution. The dashboard server software module 45 then goes to step 70 and determines if there is an advertisement to be served to the mobile device 10 of this particular user. If there is an ad to be served, the dashboard server software module 45 goes to step 72 and serves or downloads the selected ad to the mobile device 10 of the user.

In step 74, the dashboard server software module 45 polls the widget to see if an update is required. If an update is required, the dashboard server software module 45 obtains the necessary update and downloads the update to the widget via the widget and dashboard engine 36. The system then goes on to check if the user profile on the mobile device 10 has been updated and if it has, in step 80 the dashboard server software module 45 updates the appropriate user profile database that may be on the dashboard server 46.

In step 82, the system checks if either any widget profile or the dashboard profile has been updated on the mobile device 10. If any profile has been changed or updated, the dashboard server software module 45 updates the appropriate widget or dashboard profiles that may reside on the dashboard server 46.

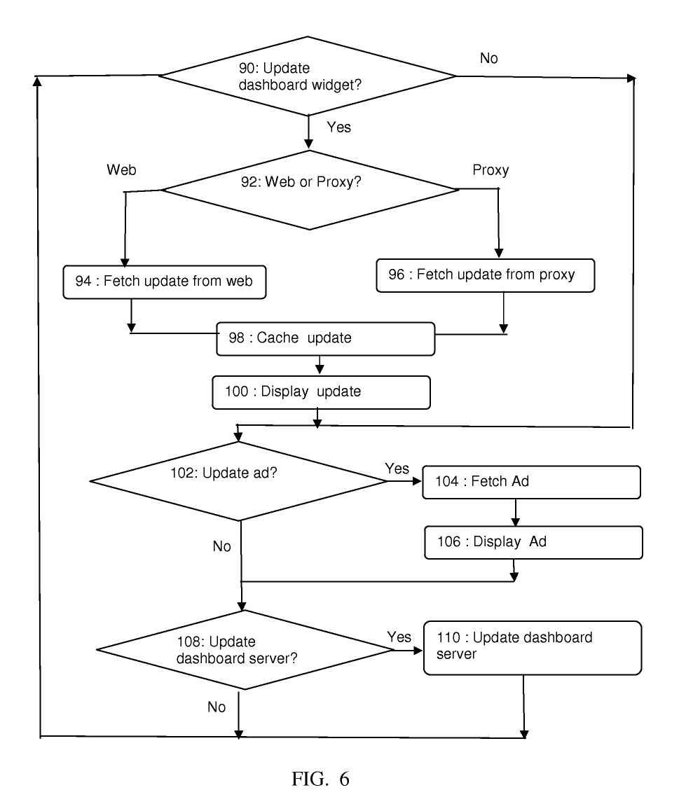

FIG. 6 shows a flow diagram of exemplary steps in implementing a widget management method in accordance with the present invention.

In step 90, the widget and dashboard engine 36 running on the mobile device 10 queries to see if any widget on the dashboard requires updating. If a widget does require updating, step 92 is a determination if that particular widget requires updating via the web or via a proxy. If a proxy is required, the widget and dashboard engine 36 fetches the required data using the proxy server 44 that typically converts data from a website 48 into a format more suitable for display on the mobile device 10. If no proxy is required, the data is fetched directly from the appropriate website 48 via the web 42.

Once the data is fetched, it may be stored in cache on the mobile device 10. In this way, when the user toggles from the phone function screen to the dashboard screen, any data to be displayed on a live icon is already available in an updated form, ready for immediate display.

In step 100 the data is displayed on the widget icons 14 of live icons, i.e., those having a display area 15.

In step 102, the widget and dashboard engine 36 checks to see if there is an updated ad to be displayed in the control banner 24. If there is a new or updated ad to be displayed, the ad may be fetched from the ad server 38 that may have obtained it via the ad network 40. In step 106, the widget and dashboard engine 36 then causes the new ad to displayed.

In step 108 the widget and dashboard engine 36 if the dashboard server needs to be updated. The updates may, for instance, be because a user has reconfigured the arrangement of their widget icons 14 on the dashboard 13, or because the settings on one or more of their widget icons 14 has been changed. These changes may need to be conveyed to the dashboard server 46 so that appropriate databases may be updated or changed.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

### INDUSTRIAL APPLICABILITY

In the field of mobile communications there is significant interest in displaying data and providing access to application on mobile devices.

What is claimed:

1. A method of displaying information, comprising:
displaying a dashboard layer on a mobile device, said dashboard layer comprising at least one live icon, said live icon being indicative of a widget and having an information display area;
aggregating a first level of information relevant to said widget; and,
configuring said information display area of said live icon to display at least some of said aggregated first level of information.

2. The method of claim 1 further comprising receiving a widget selection; aggregating a second level of information relevant to a second level of said selected widget; and configuring said selected widget to display at least some of said aggregated second layer information.

3. The method of claim 2 further comprising displaying on said widget configured to display at least some of said aggregated second layer information, an icon indicative of a third level of said widget.

4. The method of claim 3 further comprising receiving a third level widget selection; aggregating a third level of information relevant to said third level widget selection; and, configuring said selected widget to display at least some of said aggregated third layer information.

5. The method of claim 4 further comprising displaying an icon indicative of a further level of said widget; receiving a further level widget selection; aggregating a further level of information relevant to said further level selection; and configuring said selected widget to display at least some of said aggregated further level data.

6. The method of one of claims 1, 2, 3, 4 and 5 further comprising receiving a message relevant to widget or level of said widget; and configuring said dashboard or said widget to display said message in a banner.

7. The method of claim 6 wherein said message is a targeted advertisement.

8. The method of claim 6 wherein said aggregated information is received from a first source, and said message is received from a second source.

9. The method of claim 6 wherein said configuring said dashboard or said widget to display said message in a banner further includes progressively building up said display.

10. The method of claim 6 wherein said widget further contains a link that is one of a content link, a click-to-call link, a click-to-SMS link and a click-to-WAP link.

11. The method of one of claims 2, 3, 4 and 5 wherein said widget occupies substantially all of a display screen of said mobile device.

12. The method of one of claims 1, 2, 3, 4 and 5 wherein said aggregating occurs in real time.

13. The method of one of claims 1, 2, 3, 4 and 5 wherein said aggregating further comprises fetching said relevant information in real-time and caching said information, thereby facilitating the display of said information immediately it is required to be displayed.

14. The method of one of claims 1, 2, 3, 4 and 5 wherein said configuring is controlled, in part, by a dashboard server.

15. The method of claim 14 wherein said control by said dashboard server is responsive to one of a user's observed behavior, a change in external information or context and an advertiser's desire to connect with a user, or some combination thereof.

16. The method of one of claims 1, 2, 3, 4 and 5 wherein said aggregating further comprises controlling a refresh rate at which said relevant information is aggregated.

17. The method of claim 16 wherein said controlling a refresh rate includes consideration of one of a user behavior and a change of context or a combination thereof.

18. The method of claim 1 wherein said live icon is displayed at a preselected position in said dashboard.

19. A system comprising:
means for displaying a dashboard layer on a mobile device, said dashboard layer comprising at least one live icon, said live icon being indicative of a widget and having an information display area;
means for aggregating a first level of information relevant to said widget; and,
means for configuring said information display area of said live icon to display at least some of said aggregated first level of information.

20. The system of claim 19 further comprising means for displaying an icon indicative of a further level of said widget; means for receiving a further level widget selection; means for aggregating a further level of information relevant to said further level selection; and means for configuring said selected widget to display at least some of said aggregated further level data.

21. The system of claim 20 further comprising means for comprising receiving a message relevant to widget or level of said widget; and means for configuring said dashboard or said widget to display said message in a banner.

22. The system of claim 21 wherein said message is a targeted advertisement.

23. A computer-readable medium, comprising instructions for:
displaying a dashboard layer on a mobile device, said dashboard layer comprising at least one live icon, said live icon being indicative of a widget and having an information display area;
aggregating a first level of information relevant to said widget; and,
configuring said information display area of said live icon to display at least some of said aggregated first level of information.

24. The computer-readable medium of claim 16 further comprising instructions for displaying an icon indicative of a further level of said widget; receiving a further level widget selection; aggregating a further level of information relevant to said further level selection; and configuring said selected widget to display at least some of said aggregated further level data.

25. The computer-readable medium of claim 24 further comprising instructions for receiving a message relevant to widget or level of said widget; and configuring said dashboard or said widget to display said message in a banner.

26. The computer-readable medium of claim 25 wherein said message is a targeted advertisement.

27. A computing device comprising: a computer-readable medium comprising instructions for:
displaying a dashboard layer on a mobile device, said dashboard layer comprising at least one live icon, said live icon being indicative of a widget and having an information display area;
aggregating a first level of information relevant to said widget; and,
configuring said information display area of said live icon to display at least some of said aggregated first level of information.

28. The computing device of claim 27 further comprising instructions for displaying an icon indicative of a further level of said widget; receiving a further level widget selection; aggregating a further level of information relevant to said further level selection; and configuring said selected widget to display at least some of said aggregated further level data.

29. The computing device of claim 28 further comprising instructions for receiving a message relevant to widget or level of said widget; and configuring said dashboard or said widget to display said message in a banner.

30. The computing device of claim 29 wherein said message is a targeted advertisement.
